(19) United States
(12) Patent Application Publication
(10) Pub. No.: US 2003/0006171 A1
(43) Pub. Date: Jan. 9, 2003

(54) Method and apparatus for testing segregation of particulate materials during shear

(76) Inventors: Virendra M. Puri, State College, PA (US); Shawn P. Duffy, Cheswick, PA (US)

Correspondence Address: MCKEE, VOORHEES & SEASE, P.L.C., ATTN: PENNSYLVANIA STATE UNIVERSITY, 801 GRAND AVENUE, SUITE 3200, DES MOINES, IA, 50309-2721, US

(21) Appl. No.: 09/900,243

(22) Filed: Jul. 6, 2001

(51) Int. Cl. B07B 1/00

(52) U.S. Cl. 209/235

(57) ABSTRACT

A method and apparatus for testing the segregation of particulate materials includes a shear cell having a top, side, and bottom walls. The shear cell is between two stationary walls in a frame and includes a cam pin which rides on top of a cam connected to a rotating motor. A collection tray, including load cells, is placed beneath the perforated bottom wall of the shear cell. Large particles are placed in the shear cell and data collection is begun. Small particles are placed on top of the larger particles and the shear cell is closed. The motor is then turned on, applying strain at a certain strain rate to the particles within the shear cell. The smaller particles percolate through the larger particles and through the perforated bottom wall into the collection tray. Load cells in the collection tray transmit data to a computer for analysis.

### GRANT REFERENCE

Work for this invention was funded in part by a grant from the United States Department of Agriculture, National Needs Award No. 95-38420-2162 (404-12, fund 754W). The United States Department of Agriculture also provided funding under Hatch Act of PEN03472. The Government may have certain rights in this invention.

### BACKGROUND OF THE INVENTION

1. Field of the Invention

The present invention generally relates to a method and apparatus for testing the segregation of particulate materials. More particularly, though not exclusively, the present invention relates to a cost effective method and apparatus for testing the percolation of small particulate materials through a bed of larger particulate materials during shear.

2. Problems in the Art

Currently, segregation of particulate materials can cause a variety of problems and have a large impact on product quality and/or mixing. For instance during mixing, smaller particulate materials tend to settle into the middle of the mix while larger particulate materials tend toward the outer edges of the mix. To achieve the proper mixing of particulate materials and/or the highest product quality, companies must take into account several factors including the proper size ratio of large particles to small particles, the proper starting depth of large particles, and the strain and strain rate to which the particles may be subjected during the mixing process. Currently, no test devices exist for quantifying segregation under dynamic conditions. Therefore, there is a need for a simplified, small and economical means for testing the segregation of particulate materials.

Features of the Invention

A general feature of the present invention is the provision of a method and apparatus for testing the segregation of particulate materials which overcomes the problems found in the prior art.

A further feature of the present invention is the provision of a method and apparatus for testing the segregation of particulate materials which is capable of analyzing various factors which may affect the percolation of small particulate materials through a bed of larger particulate materials.

Another feature of the present invention is a method and apparatus for testing the segregation of particulate materials which is both economical and easy to use.

A still further feature of the present invention is a method and apparatus for testing the segregation of particulate materials during shear.

These, as well as other features and advantages of the present invention, will become apparent from the following specification and claims.

### SUMMARY OF THE INVENTION

The present invention generally comprises a method and apparatus for testing the segregation of particulate materials. The segregation testing apparatus generally comprises a flexible container with a mesh or perforated bottom. A collection tray is placed underneath the flexible container. Preferably, the collection tray is composed of a plurality of compartments. A standard load cell is placed in the collection tray in one or more of the compartments. The load cell is operatively connected to equipment which is capable of generating data based on the amount of particulate material which falls on the load cell.

Initially, the larger particulate materials are placed inside the flexible container. The size of the perforated, apertured, or mesh bottom of the container is such that it does not allow the larger particulate materials to escape from the flexible container. Further, the size of the mesh prevents the larger particulate materials from completely blocking the mesh.

After the larger particles have been placed in the flexible container, a computer, or other analysis equipment, is turned on, or begins recording data from the load cells in the collection tray. Next, the finer or smaller particulate materials are placed on top of the larger particulate materials in the flexible container. The flexible container is then closed. A shear strain is then applied to the flexible container by repeatedly moving the container walls (left, right, and top, bottom) in an up and down motion.

The movement is preferably accomplished by a rotational motor which rotates a cam. A cam pin, connected to the flexible container, rides on top of the cam and therefore pushes the flexible container up and down. The shear strain applied to the flexible container causes the smaller particulate materials to percolate through the larger particulate materials and fall into the collection tray. The amount of the smaller particulate materials in the collection tray is recorded by the load cells on the computer for analysis. By repeating this process the user can test the percolation rate resulting from different size ratios of larger particulate materials to smaller particulate materials, differing bed heights of larger particulate materials, differing amounts of shear strain and differing shear strain rates in a low cost and efficient manner.

### BRIEF DESCRIPTION OF THE DRAWINGS

FIG. 1 is a side view of the preferred embodiment of the testing apparatus of the present invention.

FIG. 2 is a perspective view of one embodiment of the collection tray of the present invention.

FIG. 3 is a perspective view of the preferred shear cell of the present invention.

FIG. 4 is a top view of the collection tray assembly showing the preferred location for load cells.

### DETAILED DESCRIPTION OF THE PREFERRED EMBODIMENT(S)

The present invention will be described as it applies to its preferred embodiment. It is not intended that the present invention be limited to the described embodiment. It is intended that the invention cover all modifications and alternatives which may be included within the spirit and scope of the invention.

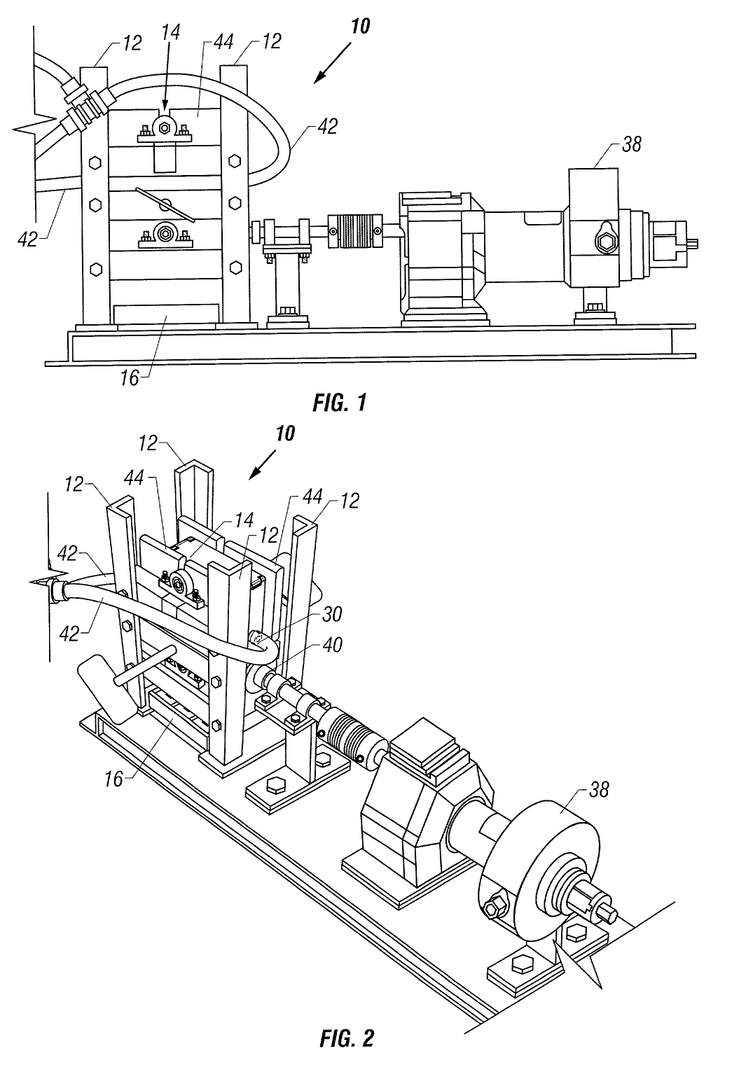

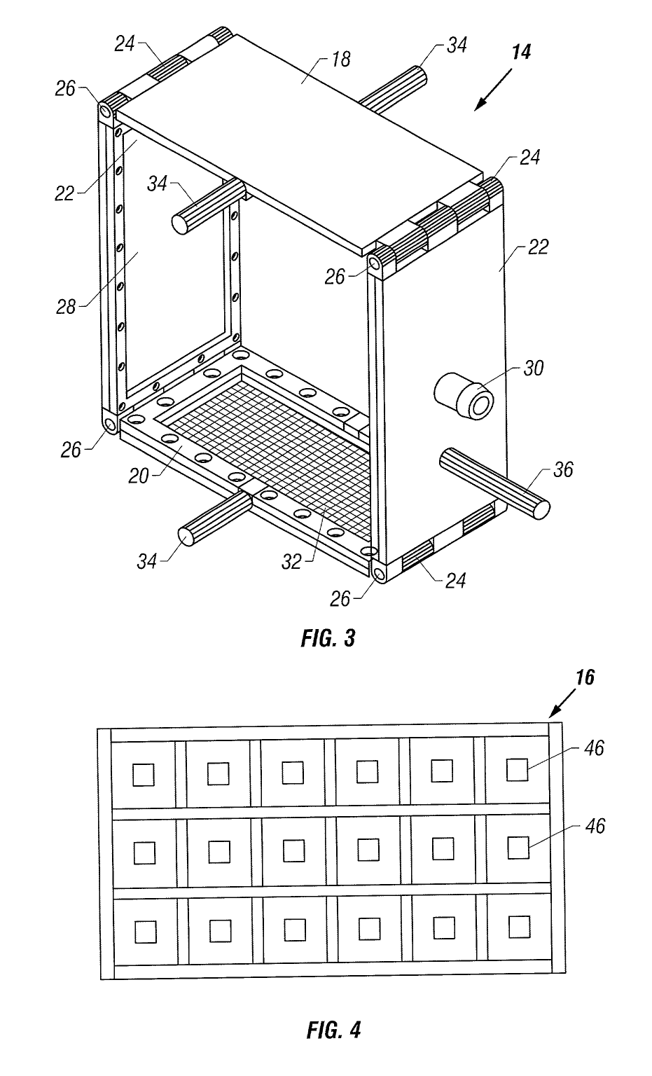

As shown in FIGS. 1 and 2, the segregation testing apparatus 10 of the present invention includes a frame 12 for a shear cell 14. A removable collection tray 16 is preferably placed directly under the shear cell 14. While the shear cell 14 may be any type of flexible container, the preferred shear cell 14 of the present invention, shown in FIG. 3, includes a top wall 18, a bottom wall 20, and side walls 22. Each of the walls have hinged edges 24. Of course, any type of flexible connection will suffice. For example, the walls may consist of flat panels which have separate hinges connected thereto. However, in the preferred embodiment the hinged edges 24 are incorporated into the top wall 18, bottom wall 20 and side walls 22. A removable pin 26 provides the pivot point for the wall connections.

As can be seen in FIG. 3, inflatable flexible membranes 28 may be included in the side walls. The inflatable flexible membranes 28 help to eliminate the volumetric strain of a rigid closed box during deformation which allows the use of an unassembled coarse bed of larger particulate materials. The flexible membranes 28 may be made out of any air tight and flexible product, but are preferably made with high grade 0.5 mm thick neoprene. Similarly, any known fastening means may be used to secure the flexible membrane 28 to the side walls 22. Preferably, the flexible membrane 28 is secured to the side wall 22 using a 3.175 mm bracket and 20-0 by 80 stainless steel machine screws.

The bottom wall 20 is perforated, or contains several holes, to allow the smaller particulate materials which percolate through larger particulate materials to be collected in the collection tray. However, as the size of the apertures in the bottom wall 20 will need to be varied depending upon the particulate materials to be tested, it is preferred that a removable mesh insert 32 be used in conjunction with the bottom wall 20. This allows the user to easily change the size of the apertures.

The bottom wall 20 includes a cut-out portion which is covered by the mesh insert 32. The mesh insert 32 may consist of any type of perforated, expanded, or woven material, including metal or plastic material. Preferably, the mesh insert 32 is a stainless steel mesh screen. The mesh insert 32 may be secured within the bottom wall 20 in any known fashion.

A gas connector 30 extends from the outer edge of the side walls 22. Gas tubing 42, shown in FIGS. 1 and 2, is attached to the gas connectors 30 on each of the side walls 22. The gas connectors 30 extend through the side walls 22 to allow gas from the gas tubing 42 to inflate or deflate the flexible membranes 28. Preferably, the gas tubing 42 consists of 15.875 mm outer diameter and 9.525 mm inner diameter flexible Tyvek tubing. While any gas may be used to inflate or deflate the flexible membranes 28, an inert gas, such as nitrogen, is preferred. To maintain a constant volume in the testing apparatus, the flexible membranes may be inflated to pressures ranging from 0 kPa to 10 kPa.

The entire shear cell 14 is then placed between two stationary walls 44 which have been mounted in the frame 12 as shown in FIG. 1. The stationary walls 44 may be tightened against the shear cell 14 but remain fixed during movement of the shear cell. The stationary side walls 44 should be made of, or coated with, nylon or another substance which minimizes the friction between the moving walls of the shear cell 14 and the stationary walls 44.

The top and bottom walls 18 and 20 of the shear cell 14 are also provided with support pins 34. The support pins 34 are fixed to the stationary walls 44 in a manner which allows the support pins 34 to freely rotate but remain in a stationary location such as clamping the support pins 34 in grooves on the stationary walls 44, with the clamp attached to the frame 12. The support pins 34 are placed in the middle of the top wall 18 and of the bottom wall 20. The support pins allow the top wall 18 and the bottom wall 20 to rotate in a set manner thereby restricting the side walls 22 to up and down movement.

Up and down movement of the side walls 22 is accomplished with the use of a motor 38. The motor 38 is preferably a variable speed motor that can cycle a cam 40 between 0.25 revolutions per second and 1.67 revolutions per second. The mesh inserts 32 has openings which prevent larger particulate materials from passing while allowing the smaller particulate materials to pass without blinding. The cam 40 may be designed in a myriad of different ways to provide strains from 5 to 25 percent. The cam should also be designed to minimize the amount of acceleration at the change of planar motion by decreasing the velocity near the change of direction. The cam 40 used to induce the strain in the shear cell 14 is created in AutoCAD by defining the profile of the cam 40 using an AutoLISP program. The program and a sample of the data created using the program for the 5% cam 40 are presented below. The data is (x y) coordinates with the center of the cam 40 (i.e., location of rotation) at (0 0). The AutoCAD drawings of the cam 40 profiles may be supplied to a machine shop with CNC milling capabilities. The AutoCAD drawings may simply be loaded into the CNC mill which cuts the cam 40 as programmed. The program is as follows:

[image]

[image]

[image]

[image]

Data For 5% Cam

(1 0)

(1.00225 0.0174943)

(1.00419 0.0350671)

(1.00582 0.0527129)

(1.00714 0.0704264)

(1.00815 0.088202)

(1.00885 0.106034)

(1.00923 0.123918)

(1.00929 0.141846)

(1.00903 0.159815)

(1.00845 0.177817)

(1.00755 0.195848)

(1.00633 0.213902)

(1.00478 0.231972)

. . .

. . .

. . .

. . .

. . .

. . .

(0.909954 -0.295662)

(0.917271 -0.280438)

(0.924334 -0.265049)

(0.931138 -0.249498)

(0.93768 -0.23379)

(0.943957 -0.21793)

(0.949965 -0.201921)

(0.955702 -0.18577)

(0.961163 -0.169479)

(0.966345 -0.153054)

(0.971247 -0.1365)

(0.975864 -0.119821)

(0.980195 -0.103023)

(0.984235 -0.0861094)

(0.987983 -0.0690865)

(0.991436 -0.051959)

(0.994592 -0.0347319)

(0.997447 -0.0174105)

The cam pin 36 rides on top of the cam 40 and is attached to one of the side walls 22 of the shear cell 14. In this manner, rotation of the cam 40 pushes the cam pin 36 up and down, applying shear strain to the particles in the shear cell 14. The cam pin 26 is fitted with a 7 mm by 14 mm roller bearing (not shown) in order to reduce the amount of friction between the cam 40 and the cam pin 36. The roller bearing also eliminates the out of plane force component during cycling. The cam pin 36 is preferably held to the cam 40 with the use of a tensioning spring (not shown).

The collection tray 16 is shown in FIGS. 1, 2, 3 and 4. The collection tray 16 is preferably aligned below the mesh insert 32 of the shear cell 14. The collection tray 16 may take any shape or size which will facilitate obtaining results. Preferably, the collection tray 16 includes eighteen individual compartments. A load cell 46 may be placed in each of the eighteen compartments, one of the compartments, or any variation therebetween.

For sampling purposes, six load cells 46 may be placed in six of the compartments to measure the percolation of small particulate materials and minimize the costs of the segregation testing apparatus 10.

Each load cell 46 preferably has a capacity of 50 grams plus or minus 0.01% (0.005 grams). Each load cell 46 is preloaded with a 5 gram plate to minimize drift and noise associated with an unloaded load cell 46. The data from the load cells 46 is then collected using a Hewlett Packard 3852A data acquisition system connected to a personal computer through the general purpose information bus. Lab VIEW software from National Instruments in Austin, Texas provides the translation from analog to digital so that the information can be processed using standard spreadsheets.

To begin testing the segregation of particulate materials in the segregation testing apparatus 10, the shear cell 14 is first secured within the frame 12 by tightening the stationary walls 44. A bead of silicon is then run along the walls of the shear cell 14 and the hinged edges 24 of the shear cell 14 to ensure that no particulate materials can escape. Once the shear cell 14 has been properly secured, one of the pins 26 which secures the top wall 18 is removed. This allows the top wall 18 to rotate up, giving the user access to the interior of the shear cell 14. Next, the flexible membranes 28 are inflated to a desired pressure, such as 2 kPa, using nitrogen gas. The collection tray 16 is then aligned with the mesh screen 32 in the bottom of the shear cell 14 using alignment guides and any necessary visual alignment marks.

The larger particulate materials, or coarse particles, are then deposited into the shear cell 14 using a spoon or any other appropriate deposition method. Deposition of the coarse particles is continued until a desired bed height is reached. Next, a fines deposition mold is aligned on top of the bed of coarse particles. The fines deposition mold (not shown) is used to uniformly spread the smaller particulate materials, or fines, on top of the larger particulate materials. Data collection is then started.

After data collection has begun, the smaller particulate materials or fines are deposited into the mold and the mold is removed. The top wall 18 of the shear cell 14 is then closed and the removed pin 26 is reinserted. The stationary walls 44 are then sufficiently relaxed from the shear cell 14 to allow the shear cell 14 to move. The motor 38 is then started. The motor 38 rotates the cam 40 which pushes the cam pin 36 and therefore the side walls 22 of the shear cell 14 in an up and down motion. This places strain upon the shear cell 14. The speed of the motor 38 can be varied to alter the strain rate placed upon the shear cell 14. The motor 38 is run for a desired amount of time until a significant amount of the smaller particulate materials have been collected. By repeating the above steps using different bed heights, size ratios, strain and strain rates, the user of the present invention may determine the best combination of large particulate materials and small particulate materials to use for the desired application given the strain and strain rate to which the particles will be subjected during the application. For instance, if a high amount of mixing is desired, the bed height, size ratio, strain, and strain rates which give the minimum amount of percolation may be discovered using the testing apparatus 10 of the present invention. In this manner, the user of the present invention may improve the mixing of particles in the larger and more costly commercial operation.

A general description of the present invention as well as a preferred embodiment of the present invention has been set forth above. Those skilled in the art to which the present inventions pertains will recognize and be able to practice additional variations in the methods and apparatus described which fall within the teachings of this invention. Accordingly, all such modifications and additions are deemed to be within the scope of the invention which is to be limited only by the claims appended hereto.

What is claimed is:

1. A testing apparatus to measure particulate segregation, the testing apparatus comprising:
a flexible container having a top wall, side walls, and a perforated bottom wall;
a motor operatively connected to a cam for movement of the container; and
a collection tray under the bottom wall of the container.

2. The testing apparatus of claim 1 wherein the side walls include a flexible membrane and gas inlets.

3. The testing apparatus of claim 1 wherein the collection tray includes a load cell.

4. The testing apparatus of claim 1 wherein the collection tray includes a plurality of compartments.

5. The testing apparatus of claim 4 wherein the collection tray includes a load cell.

6. The testing apparatus of claim 4 wherein the collection tray includes load cells selectively placed in the compartments of the collection tray.

7. An apparatus for testing segregation of particulate matter, the apparatus comprising:
a frame including at least two stationary walls;
a shear cell movably secured between the stationary walls of the frame, the shear cell including a top wall, side walls, and an apertured bottom wall;
a motor for moving the cell shear; and
a collection tray under the bottom wall of the shear cell.

8. The apparatus for testing segregation of particulate matter of claim 7 wherein the top wall, side walls, and bottom wall of the shear cell are hinged together.

9. The apparatus for testing segregation of particulate matter of claim 7 wherein the top wall of the shear cell is removable.

10. The apparatus for testing segregation of particulate matter of claim 7 wherein the stationary walls are nylon.

11. The apparatus for testing segregation of particulate matter of claim 7 further comprising a first support pivot attached to the top wall and a second support pivot attached to the bottom wall, the first and second support pivots being rotatably secured to at least one of the stationary walls.

12. The apparatus for testing segregation of particulate matter of claim 7 wherein the side walls include an inner surface and an outer surface, a flexible membrane secured to the inner surface, and a gas connector on the outer surface to allow gas to expand or contract the flexible membrane.

13. The apparatus for testing segregation of particulate matter of claim 7 wherein the collection tray includes a load cell.

14. The apparatus for testing segregation of particulate matter of claim 13 wherein the load cell is operatively connected to a computer.

15. A method of testing segregation of small particulate materials from large particulate materials under shear stress, the method comprising:
securing a shear cell between two stationary walls, the shear cell including a top wall, side walls, and an apertured bottom wall;
opening the shear cell;
depositing the large particulate materials into the shear cell;
collecting data from the load cells located in a collection tray, the collection tray located beneath the apertured bottom wall of the shear cell;
depositing the small particulate materials into the shear cell; closing the shear cell; and moving the shear cell.

16. The method of testing the segregation of small particulate materials from large particulate materials of claim 15 wherein the small particulate materials are placed in a mold and then deposited on top of the large particulate materials.

17. The method of testing the segregation of small particulate materials from large particulate materials of claim 15 further comprising:
tightening the stationary walls against the shear cell;
relaxing the stationary walls before moving the shear cell.

18. The method of testing the segregation of small particulate materials from large particulate materials of claim 15 further comprising inflating flexible membranes secured to the side walls of the shear cell.

19. The method of testing the segregation of small particulate materials from large particulate materials of claim 18 wherein the flexible membranes are inflated to a pressure of 0-10 kPa.
